(19) United States
(12) Patent Application Publication
(10) Pub. No.: US 2009/0243472 A1
(43) Pub. Date: Oct. 1, 2009

(54) FLAT PANEL DISPLAY DEVICE

(76) Inventors: Dong-Seob Jeong, Suwon-si (KR); Sam-Il Kho, Suwon-si (KR); Sung-Woo Cho, Suwon-si (KR); Jae-Young Cho, Suwon-si (KR)

Correspondence Address: CHRISTIE, PARKER & HALE, LLP, PO BOX 7068, PASADENA, CA, 91109-7068, US

(21) Appl. No.: 12/370,500

(22) Filed: Feb. 12, 2009

(30) Foreign Application Priority Data
Mar. 25, 2008 (KR) 10-2008-0027363

(51) Int. Cl. H01J 1/62; G01J 1/32

(52) U.S. Cl. 313/504; 250/205

(57) ABSTRACT

A flat panel display device including: a plurality of sub-pixels for emitting light having different wavelengths; and an intensity adjusting layer in a light path of at least one sub-pixel from among the plurality of sub-pixels and for adjusting an intensity of light emitted from a corresponding sub-pixel of the at least one sub-pixel.

### CROSS-REFERENCE TO RELATED PATENT APPLICATION

This application claims priority to and the benefit of Korean Patent Application No. 10-2008-0027363, filed on Mar. 25, 2008, in the Korean Intellectual Property Office, the entire content of which is incorporated herein by reference.

### BACKGROUND OF THE INVENTION

1. Field of the Invention

The present invention relates to a flat panel display device, and a method of driving the same.

2. Description of the Related Art

In general, flat panel display devices are display devices including pixels. Each pixel includes a plurality of sub-pixels and emits light having various colors by a combination of light emitted from each sub-pixel included therein.

If each sub-pixel included in a pixel of a conventional flat panel display device emits light having a maximum intensity, the combined (or mixed) light may be white light if the maximum intensity of each sub-pixel is similar. However, each sub-pixel included in a pixel of the conventional flat panel display device has a different light emitting efficiency or light efficiency, and the pixel does not emit white light when light having the maximum intensity is emitted. The conventional flat panel display device cannot display an image having an exact color due to an inconsistency in white balance. For example, although white light having color coordinates (0.31, 0.31) may have a spectrum ratio of 0.65:0.5:1 in red, green, and blue light, since red, green, and blue sub-pixels do not substantially emit light having the above intensity ratio, a pixel including the red, green, and blue sub-pixels does not emit white light having the color coordinates (0.31, 0.31).

### SUMMARY OF THE INVENTION

An aspect of an embodiment of the present invention is directed toward a flat panel display device capable of easily adjusting an intensity ratio of light emitted from sub-pixels.

An embodiment of the present invention provides a flat panel display device including: a plurality of sub-pixels for emitting light having different wavelengths; and an intensity adjusting layer in a light path of at least one sub-pixel from among the plurality of sub-pixels and for adjusting an intensity of light emitted from the at least one sub-pixel.

The intensity adjusting layer may be in a light path of each sub-pixel and corresponds to each sub-pixel.

The intensity adjusting layer may be configured to adjust the intensity of the light emitted from each sub-pixel at a different ratio.

The intensity adjusting layer may be configured to adjust the light emitted from the sub-pixels to have different intensity ratios.

The intensity adjusting layer may be configured to adjust the intensity of the light emitted from each sub-pixel so that the light transmitted through the intensity adjusting layer is white light.

The intensity adjusting layer may be configured to adjust the intensity of the light at a wavelength of maximum intensity from among the light emitted from each sub-pixel.

The intensity adjusting layer may be configured to reduce the intensity of the light emitted from each sub-pixel by a predetermined amount to adjust the intensity of the light.

Each sub-pixel may include an organic light emitting element.

Another embodiment of the present invention provides a flat panel display device including: a first electrode and a second electrode facing each other; an intermediate layer between the first electrode and the second electrode and including an emitting layer for emitting light having a plurality of intensity peaks; and an intensity adjusting layer in a light path through which light emitted from the emitting layer of the intermediate layer is emitted to outside of the display device, the intensity adjusting layer configured to adjust an intensity at peaks of the light emitted from the emitting layer.

The intensity adjusting layer may be configured to adjust the intensity of the light at each peak at a different ratio.

The intensity adjusting layer may be configured to adjust the light at the peaks to have different intensity ratios.

The intensity adjusting layer may be configured to adjust the intensity of the light at each peak so that the light transmitted through the intensity adjusting layer is white light.

The intensity adjusting layer may be configured to reduce the intensity of the light at each peak by a predetermined amount to adjust the intensity of the light.

Another embodiment of the present invention provides a method for adjusting an intensity of light output by light emission of a flat panel display device comprising a plurality of pixels, each pixel comprising a plurality of sub-pixels having different colors, the method including: emitting light having an at least one peak; and adjusting an intensity of the light by utilizing an intensity adjusting layer in a light path of the light.

The intensity adjusting layer may adjust the intensity of the light having a plurality of peaks at each peak at a different ratio.

The intensity adjusting layer may adjust the light having a plurality of peaks at each peak to have different intensity ratios.

The intensity adjusting layer may adjust the intensity of the light having a plurality of peaks at each peak so that the light transmitted through the intensity adjusting layer is white light.

The intensity adjusting layer may reduce the intensity of the light having a plurality of peaks at each peak by a predetermined amount to adjust the intensity of the light.

### BRIEF DESCRIPTION OF THE DRAWINGS

The accompanying drawings, together with the specification, illustrate exemplary embodiments of the present invention, and together with this description, serve to explain the principles of the present invention.

FIG. 1 is a graph illustrating a spectrum of light having a peak according to an embodiment of the present invention;

FIG. 2 is a cross-sectional view illustrating a flat panel display device according to an embodiment of the present invention;

FIG. 3 is a graph illustrating the intensity of light transmitted through an intensity adjusting layer according to different thicknesses of the intensity adjusting layer with respect to wavelength, according to an embodiment of the present invention;

FIG. 4 is a cross-sectional view illustrating a flat panel display device, according to another embodiment of the present invention;

FIG. 5 is a graph illustrating the intensity of light transmitted through an intensity adjusting layer according to materials and/or thicknesses of the intensity adjusting layer with respect to wavelength, according to an embodiment of the present invention; and

FIG. 6 is a simplified cross-sectional view illustrating a flat panel display device, according to another embodiment of the present invention.

### DETAILED DESCRIPTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

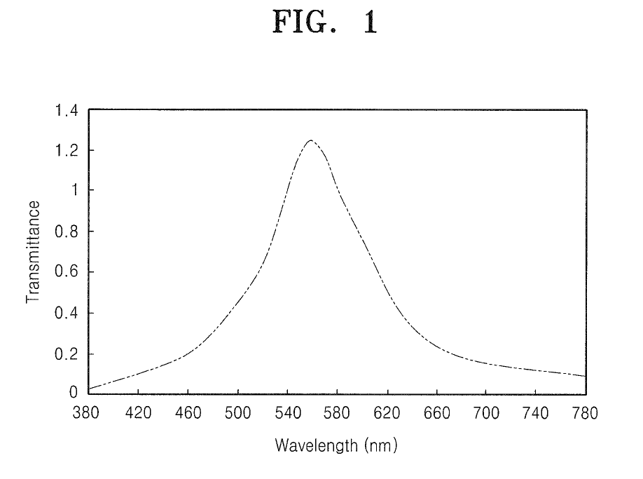

FIG. 1 is a graph illustrating a spectrum of light having a peak according to an embodiment of the present invention. Referring to FIG. 1, the light has the peak at a wavelength of approximately 560 nm, corresponding to green light. A vertical axis is an intensity ratio of the light with respect to wavelength. A pixel that emits light having a variety of colors can be formed by combining a sub-pixel that emits the light having the wavelength corresponding to the green light and a sub-pixel that emits the light having a wavelength corresponding to light other than the green light. However, a peak intensity of the green light that is emitted from the sub-pixel emitting the green light and a peak intensity of the light that is emitted from the sub-pixel emitting light other than the green light can be different from each other, according to the characteristics of the sub-pixels. While it may be preferable in some cases for sub-pixels to have different peak intensities, even in these cases, the peak intensity ratios should be a desired (e.g., predetermined) ratio. Such desired peak intensity ratio is not always achieved. In such cases, when each sub-pixel included in a pixel emits light having a maximum intensity, the light emitted from the pixel may not be white light.

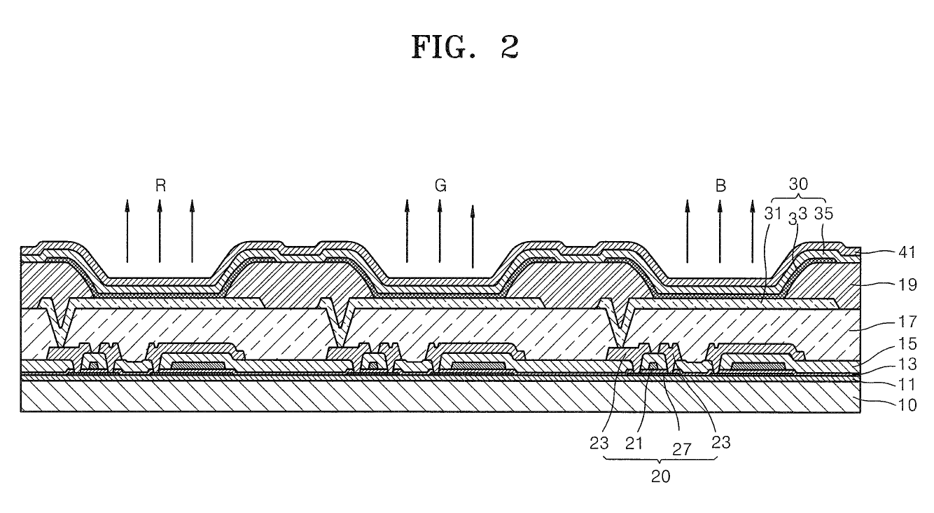

FIG. 2 is a cross-sectional view illustrating a flat panel display device, according to an embodiment of the present invention. Referring to FIG. 2, the flat panel display device of the present embodiment includes a plurality of sub-pixels that emit light having different wavelengths, and an intensity adjusting layer 41 that is disposed in a light path of at least one sub-pixel among the plurality of sub-pixels and adjusts an intensity of light emitted from a corresponding sub-pixel. While the intensity adjusting layer 41 shown in FIG. 2 is in the light path of all three sub-pixels, the present invention is not limited thereto, and the intensity adjusting layer may correspond to only one or two sub-pixels in other embodiments. The plurality of sub-pixels includes a red sub-pixel for emitting light having a wavelength mainly corresponding to red light R, a green sub-pixel for emitting light having a wavelength mainly corresponding to green light G, and a blue sub-pixel for emitting light having a wavelength mainly corresponding to blue light B. The present invention is not limited thereto, and a flat panel display device in another embodiment may include a sub-pixel that emits light having a wavelength mainly corresponding to light of a different color.

In more detail, each sub-pixel includes an organic light emitting element 30. More particularly, the flat panel display device of the present embodiment is an active matrix flat panel display device that controls whether the organic light emitting element 30 emits light and how much light it emits, by using a thin film transistor 20. The present invention is not limited thereto, and a flat panel display device including a plurality of sub-pixels and the intensity adjusting layer 41 is within the scope of the present invention. Each sub-pixel including the organic light emitting element 30 will now be described in brief.

The flat panel display device of the present embodiment includes a substrate 10. The substrate 10 can be formed of a variety of materials, such as glass, metal, or plastic. The plurality of sub-pixels, each including the organic light emitting element 30, is disposed on the substrate 10. In more detail, each sub-pixel of the flat panel display device of the present embodiment, which is an organic light emitting display device, includes the organic light emitting element 30 including a pixel electrode 31, a facing electrode 35 facing the pixel electrode 31, and an intermediate layer 33, including at least an emitting layer, disposed between the pixel electrode 31 and the facing electrode 35. The organic light emitting element 30 and the other elements will now be described in detail.

A buffer layer 11 is formed of silicon oxide or silicon nitride and is disposed on the substrate 10. A thin film transistor 20 is disposed on one surface of the buffer layer 11. The organic light emitting element 30 is disposed on the thin film transistor 20, and includes the pixel electrode 31 electrically coupled to the thin film transistor 20, the facing electrode 35 disposed over the entire surface of the substrate 10, and the intermediate layer 33, including at least an emitting layer, disposed between the pixel electrode 31 and the facing electrode 35.

The thin film transistor 20 includes a gate electrode 21, source and drain electrodes 23, a semiconductor layer 27, a gate insulation film 13, and an interlayer insulation film 15. The thin film transistor 20 is not limited to the structure described above and various kinds of thin film transistors, such as an organic thin film transistor and a silicon thin film transistor, with the semiconductor layer 27 respectively including an organic material and silicon, may be used as the thin film transistor 20.

The gate electrode 21 is formed on a portion of the upper surface of the semiconductor layer 27. The source and drain electrodes 23 are made electrically conductive according to a signal applied to the gate electrode 21. The gate electrode 21 may be formed of a material, for example, MoW, Al/Cu, etc., in consideration of adherence to an adjacent layer, a surface flatness of a stacked layer, workability, etc. In order to obtain insulation between the semiconductor layer 27 and the gate electrode 21, for example, gate insulation film 13 formed of silicon oxide is disposed between the semiconductor layer 27 and the gate electrode 21.

The interlayer insulation film 15 is formed over the gate electrode 21 and may be a single layer or multiple layers formed of silicon oxide or silicon nitride. The material of the interlayer insulation film 15 is not limited thereto and various kinds of interlayer insulation films can be used, which are applied to the other elements. The source and drain electrodes 23 are formed over the interlayer insulation film 15. The source and drain electrodes 23 are electrically coupled to the semiconductor layer 27 via a contact hole formed in the interlayer insulation film 15 and the gate insulation film 13.

A planarization film 17 (or a protective film) is formed over the source and drain electrodes 23 to protect and planarize the thin film transistor 20 disposed therebelow. Various kinds of planarization films 17 can be formed of an organic material such, as benzocyclobutene (BCB) or acryl, or an inorganic material, such as silicon nitride, and may be a single layer, a double layer, or multiple layers.

The organic light emitting element 30 is formed on the planarization film 17. The organic light emitting element 30 includes the pixel electrode 31, the facing electrode 35 facing the pixel electrode 31, and the intermediate layer 33, including at least an emitting layer, disposed between the pixel electrode 31 and the facing electrode 35.

The pixel electrode 31 serves as an anode electrode. The facing electrode 35 serves as a cathode electrode. The pixel electrode 31 and the facing electrode 35 may have opposite polarities.

The pixel electrode 31 may be a transparent electrode or a reflective electrode. The transparent electrode may be formed of Indium Tin Oxide (ITO), Indium Zinc Oxide (IZO), Zinc Oxide (ZnO), or Indium (III) oxide (In₂O₃). The reflective electrode may include a reflective film formed of Ag, Mg, Al, Pt, Pd, Au, Ni, Nd, Ir, Cr, or a compound thereof, and a film formed of ITO, IZO, ZnO, or In₂O₃ disposed on the reflective film. In the present embodiment, the pixel electrode 31 is a reflective electrode so that light generated in the intermediate layer 33 is emitted to the outside through the facing electrode 35 instead of the pixel electrode 31. However, the present invention is not limited thereto.

The facing electrode 35 may be a transparent electrode or reflective electrode. The transparent electrode may include a film formed of Li, Ca, LiF/Ca, LiF/Al, Al, Mg, or a compound thereof, and an auxiliary electrode or a bus electrode line formed of a material forming a transparent electrode, such as ITO, IZO, ZnO, or In₂O₃ disposed on the film. The reflective electrode may be formed by depositing Li, Ca, LiF/Ca, LiF/AI, Al, Mg, or a compound thereof. In the present embodiment, the facing electrode 35 is a transparent electrode so that light generated in the intermediate layer 33 is emitted to the outside through the facing electrode 35. However, the present invention is not limited thereto.

Also, a pixel defining layer (PDL) 19 covers the edges of the pixel electrode 31 and extends outward from the pixel electrode 31. The PDL 19 defines a light emitting area, and increases a gap between edges of the pixel electrode 31 and the facing electrode 35 to reduce or prevent an electric field concentration at the edges of the pixel electrode 31 in order to prevent the pixel electrode 31 and the facing electrode 35 from being short-circuited.

The intermediate layer 33, including at least an emitting layer, is disposed between the pixel electrodes 31 and the facing electrode 35. The intermediate layer 33 may be formed of low molecular weight substances or polymers.

When low molecular weight substances are used, a hole injection layer (HIL), a hole transport layer (HTL), an emission layer (EML), an electron transport layer (ETL) and an electron injection layer (EIL) are sequentially stacked. Each of the layers can be multi-layer. Also, various materials including copper phthalocyanine (CuPc), N,N′-Di(naphthalene-1-yl)-N,N′-diphenyl-benzidine (NPB), and tris-8-hydroxyquinoline aluminum (Alq3) may be used. These low molecular weight substances may be formed by vacuum deposition using masks.

The polymers may have a structure, including the HTL and the EML. Here, a polymer, such as PEDOT, is used as the HTL, and polymers, such as Poly-Phenylenevinylene (PPV) and Polyfluorene, are used as the EML.

As described above, in the present embodiment, since the pixel electrode 31 is a reflective electrode, so that light generated in the intermediate layer 33 is emitted to the outside through the facing electrode 35 instead of the pixel electrode 31, the intensity adjusting layer 41 is disposed over the facing electrode 35 so that the intensity adjustment may be performed in a light path of light generated in the intermediate layer 33. Although the intensity adjusting layer 41 is disposed to correspond to each sub-pixel, various kinds of intensity adjusting layers can be used and the intensity adjusting layer 41 is disposed in a light path of at least one sub-pixel from among the plurality of sub-pixels. The intensity adjusting layer 41 adjusts the intensity of light emitted from a corresponding sub-pixel. The intensity adjusting layer 41 may be formed of an organic material, such as Alq3, N,N′-Bis(naphthalene-1-yl)-N,N′-bis(phenyl) benzidine, etc. or an inorganic material, such as silicon oxide, silicon nitride, etc.

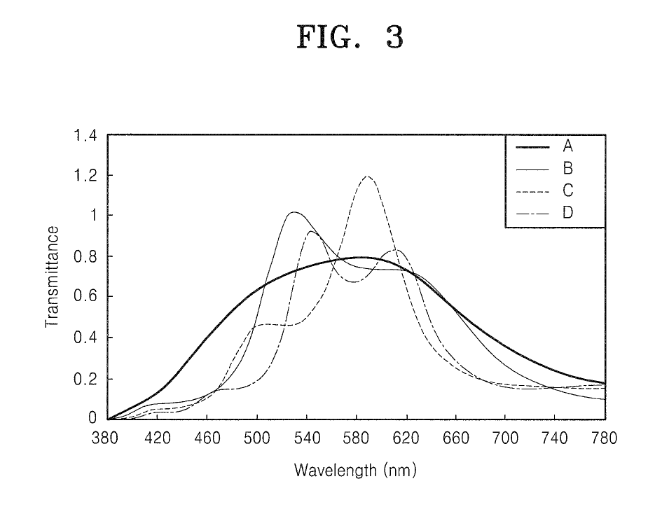

FIG. 3 is a graph illustrating the intensity of light transmitted through an intensity adjusting layer according to different thicknesses of the intensity adjusting layer with respect to wavelengths, according to an embodiment of the present invention. In more detail, FIG. 3 is a graph illustrating intensity variations of light transmitted through an intensity adjusting layer when intensity adjusting layers having various thicknesses are disposed over a sub-pixel that emits light having the spectrum shown in FIG. 1.

Referring to FIG. 3, the intensity adjusting layers are formed of N,N′-Bis(naphthalene-1-yl)-N,N′-bis(phenyl) benzidine, and have different thicknesses. A, B, C, and D indicate the intensity adjusting layer having a thickness of 40 nm, 200 nm, 300 nm, and 500 nm, respectively.

FIG. 3 shows that the intensity of light of the spectrum shown in FIG. 1 varies according to wavelength due to the intensity adjusting layer. In more detail, when an intensity adjusting layer having a thickness of 40 nm (A) is used, a peak intensity is still at a portion corresponding to green light, whereas the peak intensity is reduced. When an intensity adjusting layer having a thickness of 200 nm (B) is used, a peak intensity is shifted toward a blue area, and the peak intensity is reduced. When an intensity adjusting layer having a thickness of 300 nm (C) is used, a peak intensity is shifted toward a red area, and the peak intensity is reduced. When an intensity adjusting layer having a thickness of 500 nm (D) is used, a peak intensity is split and shifted toward a blue area and red area, and the peak intensity is reduced. The adjusting of the thickness of the intensity adjusting layer makes it possible to adjust the distribution and/or peak intensity of the spectrum.

As described above, for a flat panel display device, when each sub-pixel included in a pixel emits light having the maximum intensity, it is desirable for the mixed light to be white light. However, each sub-pixel included in a pixel of the conventional flat panel display device has a different light emitting efficiency or light efficiency, and the pixel does not emit white light when each sub-pixel emits light having the maximum intensity. The conventional flat panel display device cannot display an image having an exact color due to an inconsistency in terms of white balance. For example, although white light having color coordinates (0.31, 0.31) may have a spectrum ratio of 0.65:0.5:1 in red, green, and blue lights, since red, green, and blue sub-pixels do not substantially emit light having the above intensity ratio, a pixel having those does not emit white light having the color coordinates (0.31, 0.31).

However, with respect to the flat panel display device of the present embodiment, the intensity adjusting layer is disposed in a light path of at least one sub-pixel from among a plurality of sub-pixels so that the intensity of light emitted from a corresponding sub-pixel is adjusted, thereby adjusting the peak intensity of the light in a desired direction. For example, in a pixel comprising a plurality of sub-pixels, in which a spectrum ratio of red light, green light and blue light is not 0.65:0.5:1, the intensity adjusting layer is disposed in a light path of the plurality of sub-pixels so that the spectrum ratio of red light, green light and blue light is 0.65:0.5:1, thereby emitting white light having color coordinates (0.31, 0.31). Therefore, a white balance is easily adjusted, and thus, an excellent quality flat panel display device can be realized. The spectrum ratio of red light, green light and blue light can be different if desired. The intensity adjusting layer of the present embodiment can be used in sub-pixels emitting light having light different from red, green, and blue lights.

With respect to the flat panel display device shown in FIG. 2, the light emitted from the intermediate layer 33 is emitted to the outside via the facing electrode 35 instead of the pixel electrode 31, and thus, the intensity adjusting layer 41 is disposed on the top portion of the facing electrode 35. However, the intensity of the light emitted from the intermediate layer 33 can be effectively controlled even when the intensity adjusting layer 41 is disposed between the intermediate layer 33 and the facing electrode 35. When the light emitted from the intermediate layer 33 is emitted to the outside via the pixel electrode 31, instead of the facing electrode 35, the intensity adjusting layer 41 is disposed below the pixel electrode 31 or between the pixel electrode 31 and the intermediate layer 33, and thus, various kinds of modifications can be used.

Although FIG. 2 shows that the intensity adjusting layer 41 is disposed in a light path of each sub-pixel, the intensity adjusting layer 41 may not be disposed in a light path of all sub-pixels. For example, if a pixel includes three sub-pixels and an intensity ratio of light emitted from the three sub-pixels needs to be adjusted, the intensity of light emitted from two of the three sub-pixels is adjusted so that the intensity ratio of light emitted from the three sub-pixels can be adjusted. In this case, the intensity adjusting layer 41 is disposed in a light path of two of the three sub-pixels. As described above, various kinds of modifications can be implemented.

Since the intensity adjusting layer adjusts the intensity of light emitted from a sub-pixel, if a pixel includes three sub-pixels, the intensity adjusting layer adjusts the intensity of light emitted from a first sub-pixel by a %, the intensity of light emitted from a second sub-pixel by b %, and the intensity of light emitted from a third sub-pixel by c %. a, b, and c may all be different values. In more detail, the intensity adjusting layer can adjust the intensity of light emitted from each sub-pixel at a different ratio. This is because the peak intensity of light emitted from each sub-pixel can be different from each other, and because sometimes it is preferable for the intensity of light emitted from each sub-pixel and transmitted through the intensity adjusting layer to be different from each other.

In order to emit white light having the color coordinates (0.31, 0.31) in a pixel, a spectrum ratio of red light, green light, and blue light that is emitted from sub-pixels included in the pixel and transmitted through the intensity adjusting layer can be 0.65:0.5:1. The intensity adjusting layer can adjust the intensity of light emitted from each sub-pixel to be different from each other. In more detail, the intensity adjusting layer adjusts the intensity of light emitted from sub-pixels so that the light transmitted through the intensity adjusting layer can be white light.

Each sub-pixel included in a pixel may not emit light having a specific single wavelength. For example, although a sub-pixel emits green light having the maximum intensity at a wavelength of 560 nm, as shown in FIG. 1, the sub-pixel may emit light having a low intensity at a wavelength corresponding to blue light and/or red light. However, the intensity adjusting layer corresponding to a sub-pixel emitting light of the spectrum shown in FIG. 1 does not react to light at all wavelengths but reacts at a wavelength of 560 nm in order to adjust the intensity of light having a corresponding wavelength. Therefore, the intensity adjusting layer may adjust the intensity of light having the maximum wavelength from among light emitted from each sub-pixel. Referring to FIGS. 1 and 3, the intensity adjusting layer reduces the intensity of light emitted from each sub-pixel by a suitable amount (e.g., a predetermined amount) of light, thereby adjusting the intensity of light.

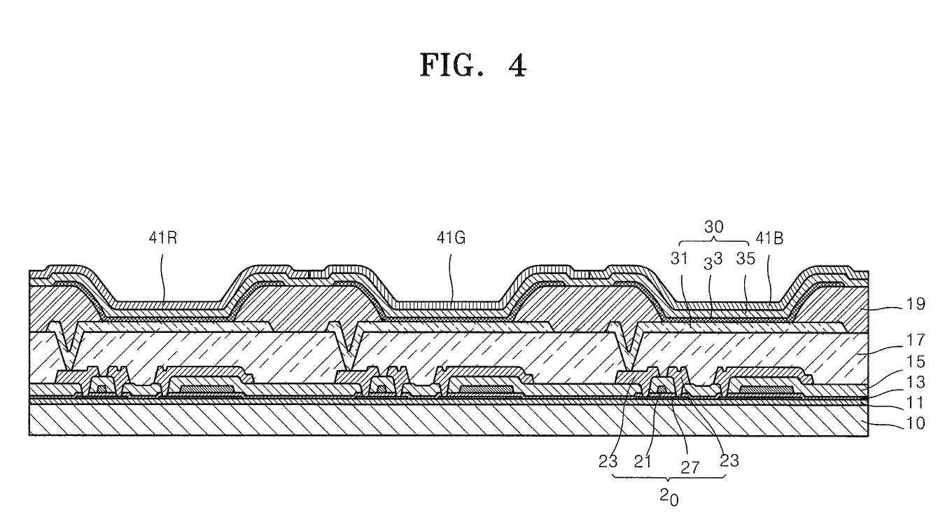

Although the intensity adjusting layer 41 is integrally formed in all sub-pixels as shown in FIG. 2, a flat panel display device can include separately a red light intensity adjusting layer 41R corresponding to a red sub-pixel, a green light intensity adjusting layer 41G corresponding to a green sub-pixel, and a blue light intensity adjusting layer 41B corresponding to a blue sub-pixel, as shown in FIG. 4, which illustrates a cross-sectional view of a flat panel display device, according to another embodiment of the present invention.

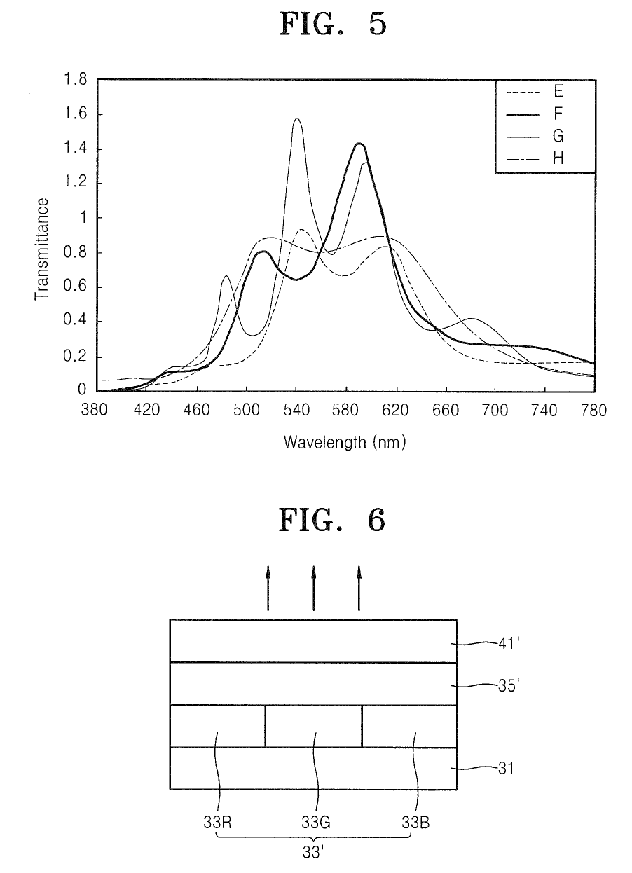

FIG. 5 is a graph illustrating the intensity of light transmitted through an intensity adjusting layer according to materials and/or thicknesses of the intensity adjusting layer with respect to wavelengths according to an embodiment of the present invention. Referring to FIG. 3, the intensity adjusting layers are formed of a material and have different thicknesses, whereas, referring to FIG. 5, the intensity of light transmitted through the intensity adjusting layers varies according to materials and/or thicknesses of the intensity adjusting layer with respect to wavelengths. Referring to FIG. 5, E indicates a spectrum distribution of the intensity adjusting layer, having a thickness of 500 nm and being formed of N,N′-Bis(naphthalene-1-yl)-N,N′-bis(phenyl) benzidine, when light having the spectrum shown in FIG. 1 is transmitted through the intensity adjusting layer. F indicates a spectrum distribution of the intensity adjusting layer, having a thickness of 500 nm and being formed of Alq3, when light having the spectrum shown in FIG. 1 is transmitted through the intensity adjusting layer. G indicates a spectrum distribution of the intensity adjusting layer, having a thickness of 800 nm and being formed of silicon nitride, when light having the spectrum shown in FIG. 1 is transmitted through the intensity adjusting layer. H indicates a spectrum distribution of the intensity adjusting layer, having a thickness of 200 nm and being formed of silicon oxide, when the light having the spectrum shown in FIG. 1 is transmitted through the intensity adjusting layer. As such, the variation of material and/or thickness of the intensity adjusting layers results in various distributions and/or intensities of the spectrum.

FIG. 6 is a simplified cross-sectional view illustrating a flat panel display device, according to another embodiment of the present invention. Referring to FIG. 6, the flat panel display device includes a first electrode 31′ and a second electrode 35′ that face each other, an intermediate layer 33′ disposed between the first electrode 31′ and the second electrode 35′ and including an emitting layer emitting light having a plurality of intensity peaks, and an intensity adjusting layer 41′, which is disposed in a light path where light emitted from the emitting layer of the intermediate layer 33′ is emitted to the outside and adjusts the intensity of peaks of light emitted from the emitting layer. The light generated in the intermediate layer 33′ is emitted to the outside via the second electrode 35′, and thus, the intensity adjusting layer 41′ is disposed on the second electrode 35′. The material and characteristics of the first electrode 31′ and the second electrode 35′ can use the material used in the pixel electrode 31 and the facing electrode 35 described in the previous embodiment. The intermediate layer 33′ can be formed of the material used in the intermediate layer 35 described in the previous embodiment.

Although the intermediate layer 33′ is divided into a part 33R for emitting red light, a part 33G for emitting green light, and a part 33B for emitting blue light, various kinds of modifications, including an intermediate layer that is not divided into three parts for emitting red light, green light, and blue light, can be used. In more detail, unlike FIG. 6, the intermediate layer that is a single layer may emit light having a plurality of intensity peaks. In this case, a color filter for filtering light emitted from the intermediate layer as red light, green light, and blue light may be disposed in the light path. In more detail, in many cases, the emitting layer included in the intermediate layer 33 emits light having a plurality of intensity peaks. The flat panel display device of the present embodiment has intensity peaks at a wavelength corresponding to red light, a wavelength corresponding to green light, and a wavelength corresponding to blue light.

In the flat panel display device, since it is necessary for light transmitted through the second electrode 35′ to be white light, the intensity adjusting layer 41′ can adjust intensity peaks of light emitted from the intermediate layer 33′.

Since the intensity adjusting layer 41′ adjusts the intensity of each peak of light, if the light emitted from the intermediate layer 33′ has three peak intensities, the intensity adjusting layer 41′ adjusts a first peak intensity by a %, a second peak intensity by b %, and a third peak intensity by c %. a, b, and c may all be different values. In more detail, the intensity adjusting layer 41′ can adjust the intensity of each peak of light emitted from each sub-pixel at a different ratio. This is because the intensity of each peak of light can be different from each other, and because sometimes it is preferable for the intensity of each peak of light transmitted through the intensity adjusting layer 41′ to be different from each other. In order to emit white light having color coordinates (0.31, 0.31), a spectrum ratio of red light, green light, and blue light that are transmitted through the intensity adjusting layer 41′ at each peak of the light emitted from the intermediate layer 33′ can be 0.65:0.5:1. The intensity adjusting layer 41′ can adjust the intensity of each peak of light to be different from each other. In more detail, the intensity adjusting layer 41′ adjusts the intensity of each peak of light so that the light transmitted through the intensity adjusting layer can be white light.

Furthermore, the intensity adjusting layer 41 reduces the intensity at a peak of light by a suitable amount (e.g., a predetermined amount) of light, thereby adjusting the intensity of light.

The flat panel display device according to embodiments of the present invention can easily adjust an intensity ratio of light emitted from sub-pixels.

While the present invention has been particularly shown and described with reference to exemplary embodiments thereof, it will be understood by those of ordinary skill in the art that various changes in form and details may be made therein without departing from the spirit and scope of the invention as defined by the appended claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A flat panel display device comprising:
a plurality of sub-pixels for emitting light having different wavelengths; and
an intensity adjusting layer in a light path of at least one sub-pixel from among the plurality of sub-pixels and for adjusting an intensity of light emitted from the at least one sub-pixel.

2. The device of claim 1, wherein the intensity adjusting layer is in a light path of each sub-pixel and corresponds to each sub-pixel.

3. The device of claim 1, wherein the intensity adjusting layer is configured to adjust the intensity of the light emitted from each sub-pixel at a different ratio.

4. The device of claim 1, wherein the intensity adjusting layer is configured to adjust the light emitted from the sub-pixels to have different intensity ratios.

5. The device of claim 1, wherein the intensity adjusting layer is configured to adjust the intensity of the light emitted from each sub-pixel so that the light transmitted through the intensity adjusting layer is white light.

6. The device of claim 1, wherein the intensity adjusting layer is configured to adjust the intensity of the light at a wavelength of maximum intensity from among the light emitted from each sub-pixel.

7. The device of claim 1, wherein the intensity adjusting layer is configured to reduce the intensity of the light emitted from each sub-pixel by a predetermined amount to adjust the intensity of the light.

8. The device of claim 1, wherein each sub-pixel comprises an organic light emitting element.

9. A flat panel display device comprising:
a first electrode and a second electrode facing each other;
an intermediate layer between the first electrode and the second electrode and including an emitting layer for emitting light having a plurality of intensity peaks; and
an intensity adjusting layer in a light path through which light emitted from the emitting layer of the intermediate layer is emitted to outside of the display device, the intensity adjusting layer configured to adjust an intensity at peaks of the light emitted from the emitting layer.

10. The device of claim 9, wherein the intensity adjusting layer is configured to adjust the intensity of the light at each peak at a different ratio.

11. The device of claim 9, wherein the intensity adjusting layer is configured to adjust the light at the peaks to have different intensity ratios.

12. The device of claim 9, wherein the intensity adjusting layer is configured to adjust the intensity of the light at each peak so that the light transmitted through the intensity adjusting layer is white light.

13. The device of claim 9, wherein the intensity adjusting layer is configured to reduce the intensity of the light at each peak by a predetermined amount to adjust the intensity of the light.

14. A method for adjusting an intensity of light output by a flat panel display device comprising a plurality of pixels, each pixel comprising a plurality of sub-pixels having different colors, the method comprising:
emitting light having an at least one peak; and
adjusting an intensity of the light by utilizing an intensity adjusting layer in a light path of the light.

15. The method of claim 14, wherein the intensity adjusting layer adjusts the intensity of the light having a plurality of peaks at each peak at a different ratio.

16. The method of claim 14, wherein the intensity adjusting layer adjusts the light having a plurality of peaks at each peak to have different intensity ratios.

17. The method of claim 14, wherein the intensity adjusting layer adjusts the intensity of the light having a plurality of peaks at each peak so that the light transmitted through the intensity adjusting layer is white light.

18. The method of claim 14, wherein the intensity adjusting layer reduces the intensity of the light having a plurality of peaks at each peak by a predetermined amount to adjust the intensity of the light.
